(19) United States
(12) Patent Application Publication
(10) Pub. No.: US 2012/0215952 A1
(43) Pub. Date: Aug. 23, 2012

(54) Protocol for Transmission of Data Over a Communication Link

(75) Inventors: Carl W. Werner, Los Gatos, CA (US); Michael J. Sobelman, Saratoga, CA (US)

(73) Assignee: RAMBUS INC., Sunnyvale, CA (US)

(21) Appl. No.: 13/501,740

(22) PCT Filed: Oct. 11, 2010
(86) PCT No.: PCT/US10/52200

§ 371 Date: Apr. 12, 2012

Related U.S. Application Data
(60) Provisional application No. 61/297,135, filed on Jan. 21, 2010.

(51) Int. Cl. G06F 13/14

(52) U.S. Cl. 710/33

(57) ABSTRACT

Video data is transmitted from a video source to a video sink via a fixed rate serial link with a substantially constant unit interval for transmission of each symbol of the encoded data. The unit interval of the serial link is maintained substantially constant, and does not vary regardless of the display parameters of the video data. The video data is encoded into a plurality of video data streams, with each data stream including a plurality of fields. The fields include at least a clock offset field and video payload data fields. The clock offset field includes phase information indicative of the phase of the display clock offset with respect to a time reference, indicated in terms of the number of unit intervals offset from the time reference. The video sink recovers the display clock based on the display clock offset information, and thus no display clock itself is transmitted from the video source to the video sink.

### BACKGROUND

The present disclosure relates to encoding data for transfer via a communication link.

When transmitting uncompressed digital video data from a video source (e.g., DVD player, set-top box, game console, etc.) to a video sink device (e.g., television, monitor, etc.), variable transport clock rates are incompatible with modern ubiquitous synchronous point-to-point communication interface standards, such as PCI Express, SATA (Serial Advanced Technology Attachment), IEEE 1394, and USB (Universal Serial Bus), for such transmission. These communication interface standards use a fixed unit interval (UI) for transmission of data symbols, and thus are incompatible with video encoding schemes such as HDMI (High-Definition Multimedia Interface) and DVI (Digital Video Interface) that use variable symbol rates for transmission of the video data over the communication channels.

### BRIEF DESCRIPTION OF THE DRAWINGS

FIG. 1 illustrates a video transmission system using a fixed unit interval serial link, according to one embodiment.

FIG. 2A illustrates an exemplary data stream format of uncompressed video data transmitted in the video transmission system using a fixed unit interval serial link, according to a first embodiment.

FIG. 2B illustrates an exemplary data stream format of uncompressed video data transmitted in the video transmission system using a fixed unit interval serial link without a fixed data stream format, according to a second embodiment.

FIG. 3 illustrates the circuitry of the video transmission system using a fixed unit interval serial link, according to one embodiment.

### DETAILED DESCRIPTION OF EMBODIMENTS

Embodiments of the present disclosure include a method and a system for transmission of serial data via a fixed unit interval serial link. Data, such as uncompressed video data, is encoded and transported via the serial link from a source device to a sink device using a constant unit interval that does not vary regardless of the display parameters of the video data. The display clock is embedded in the transported data stream and recovered at the sink device. The data is encoded into a plurality of data streams, with each data stream including a plurality of fields. The fields include at least a clock offset field and one or more payload fields. The payload fields may contain video data, audio data, or control information. The clock offset field includes phase information indicative of the phase of the clock offset with respect to a time reference. The time reference may be a particular transition or field within the data stream. The clock offset is indicated in terms of the number unit intervals offset from the time reference. Herein, the term “unit interval” refers to the amount of time during which a symbol of data is transmitted. The clock signal can be recovered at the sink device based on the clock offset information with respect to the time reference. Thus, no dedicated or explicit clock itself needs to be transmitted from the data source to the data sink with the encoded data.

In one embodiment, each data stream has a fixed packet length and the fields of each packet are positioned at predetermined locations within each packet. Also, the time reference is a “start of packet” field of the data packet. In another embodiment, each data stream has a variable length set by placement of one or more control characters, and the fields of each data stream have fixed lengths but are positioned at variable locations within each data stream. Also, the time reference is one of the control characters preceding the clock offset field in each data stream. Herein, the term “control character” refers to a collection of non-data characters or symbols indicating out-of-band control.

Reference will now be made to several embodiments of the present disclosure, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the disclosure described herein.

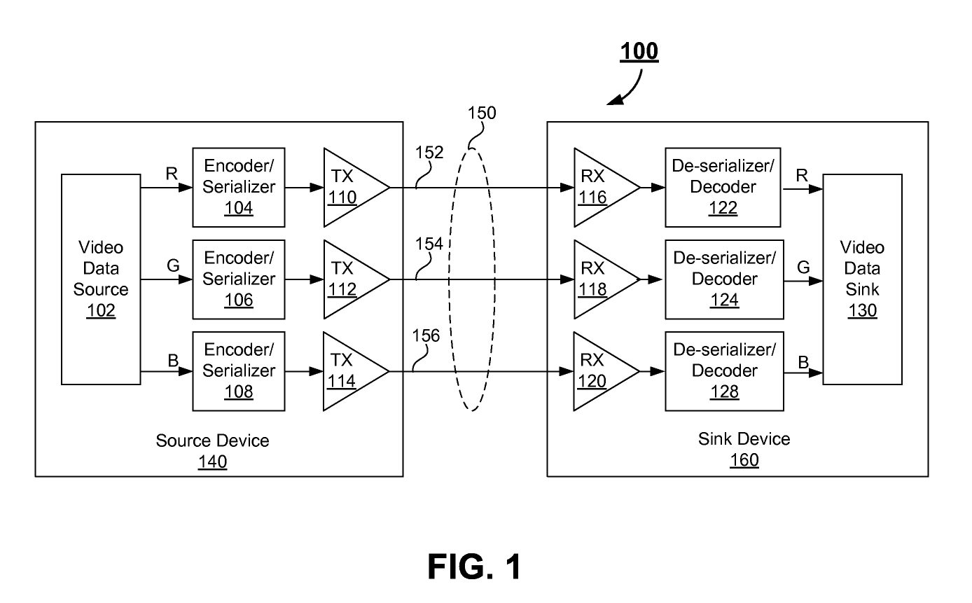

FIG. 1 illustrates a video transmission system using a fixed unit interval serial link, according to one embodiment. Although FIG. 1 illustrates a video transmission system by way of example, the data transmission scheme illustrated herein is not limited to video applications and can be used with transmission of any type of serial data, including video data, audio data, etc.

The video transmission system 100 includes a source device 140 (e.g., computer, DVD player, game console, set-top box) and a sink device 160 (e.g., television or monitor). The source device 140 transmits uncompressed digital component video streams, such as RGB (Red, Green, and Blue) data or YP_{b}Pᵣ data, to sink device 160 for display, via the serial link 150. The embodiments will be described herein as transmitting R, G, B data by way of example, although they can be configured to transmit any other type of digital data streams. Serial link 150 includes links 152, 154, 156 corresponding to the R, G, B data, respectively. Each link 152, 154, 156 may be an embedded clock serial communication link that operates with a fixed unit interval (constant baud rate) for transfer of data, such as a PCI Express interface, SATA interface, IEEE 1394 interface, or a USB interface. Serial link 150 may be implemented using a wired link. The unit interval of each of the serial links 152, 154, 156 is fixed and independent of the pixel clock frequency (or other display clock frequencies) or the payload rate, and correspondingly the display parameters, of the video data being transmitted over the serial link 150. The pixel clock (or the line clock or the frame clock) is set by the display parameters (e.g., number of scan lines, frame refresh rate, etc.) of the video data and does not have any relation to the constant unit interval (or baud rate) of the serial link 150. In video data, each scan line has a set number of pixels and each frame has a set number of scan lines. Video displays at a fixed frame update rate, with a fixed number of scan lines per frame, and a fixed number of pixels per scan line, resulting in a collection of fixed ratiometric clocks relating to the video data. Thus, one of the pixel clock, scan line clock, and frame refresh rate may be derived from another one of the pixel clock, scan line clock, and frame refresh rate. The term “display clock” herein is used to denote any one of the pixel clock, scan line clock, or frame refresh rate or any other clock by which the video data or payload data is encoded. Also, when other types of serial data other than video data is transmitted using the embodiments herein, the term “display clock” may be interchangeable with terms “byte clock” or “symbol clock” or “payload clock” denoting the clock associated with the characteristics of the transmitted data. In contrast, the “baud rate” of the serial link herein may denote the rate at which a symbol of video data is transmitted over the serial link 150. Thus, baud rate may be the inverse of a unit interval.

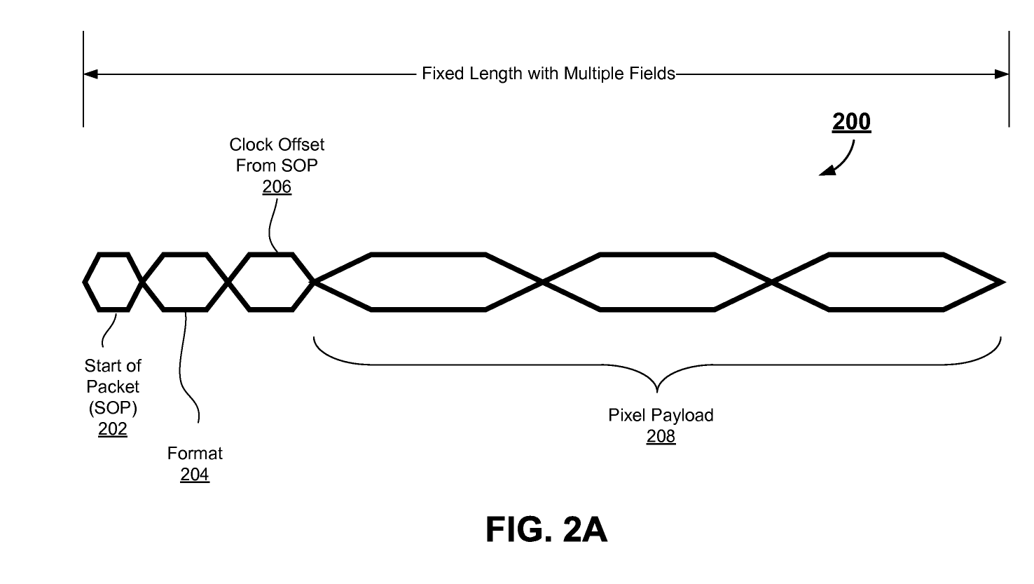

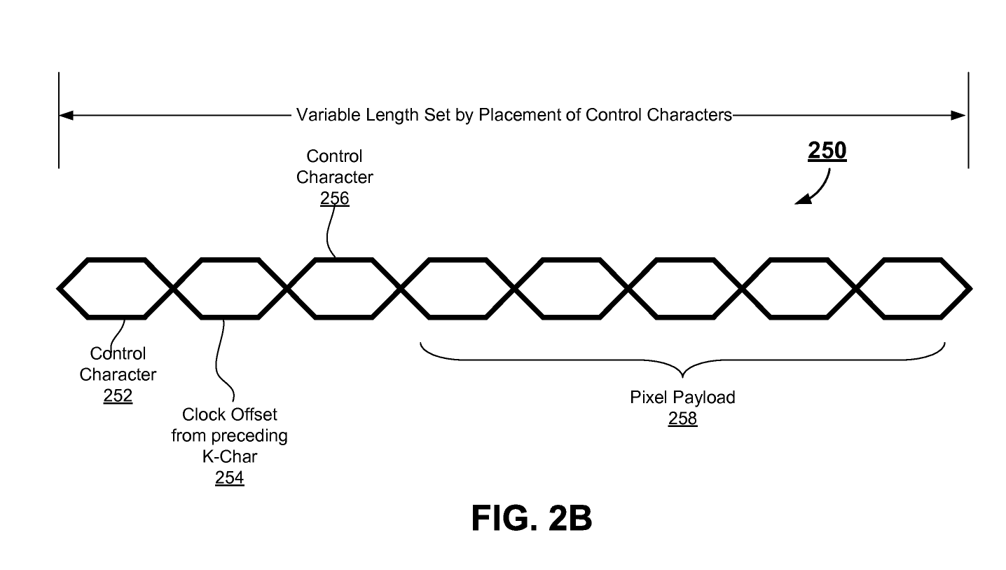

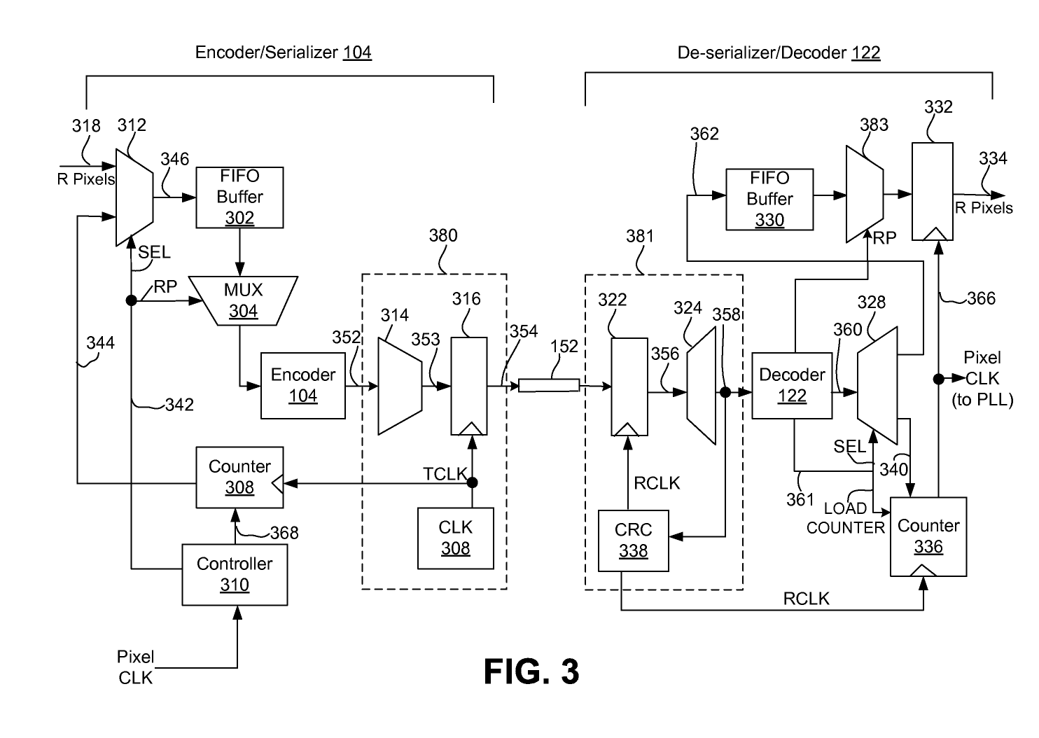

Source device 140 includes a video data source 102, encoder/serializer circuits 104, 106, 108, and transmitter (TX) circuits 110, 112, 114. Each of the encoder/serializer circuits 104, 106, 108 is configured to encode and serialize the corresponding R, G, B data, respectively, output from video data source 102. The R, G, B data is encoded according to the data stream sequence as will be described below in more detail with reference to FIG. 2A or FIG. 2B. Each of the R, G, B video data is encoded into a sequence of data streams according to the embodiments shown in FIG. 2A or FIG. 2B. In one embodiment as shown in FIG. 2A, the video data is encoded into a data stream sequence that can have a fixed overall packet length with multiple fields, in which the regenerated pixel clock timing (at video sink 160) is denoted by a clock offset with respect to the start of the packet. In another embodiment as shown in FIG. 2B, the video data is encoded into a data stream sequence that has a variable overall length set by placement of control characters. The rising (or falling) edge of the pixel clock (when regenerated at video sink 160) is denoted by a clock offset with respect to a preceding control character which indicates that the clock offset count will follow. In either embodiment of FIG. 2A or FIG. 2B, the clock offset is indicated in terms of the number of unit intervals of the serial link 150 with respect to a time reference, indicated by the start of the packet in the embodiment of FIG. 2A or the preceding control character in the embodiment of FIG, 2B. One example of the circuitry of the encoder/serializers 104, 106, 108 configured to implement the encoding scheme of FIG. 2A or 2B is described below in detail with reference to FIG. 3. Each of transmitter (TX) circuits 110, 112, 114 (see FIG. 1), possibly implemented as voltage mode or current mode transmitters, is configured to transmit the encoded R, G, B data to sink device 160 via the serial link 150. There may be other conventional circuit components present in source device 140 but not described herein so as not to unnecessarily obfuscate the concepts of this embodiment.

Sink device 160 includes receivers (RX) 116, 118, 120, de-serializer/decoder circuits 122, 124, 128, and a video data sink 130. Receivers (RX) 116, 118, 120 receive the encoded, serialized R, G, B video data via the serial links 152, 154, 156, respectively, and provide the received video data to de-serializer/decoders 122, 124, 128, respectively. Each of the de-serializer/decoder circuits 122, 124, 128 is configured to deserialize and decode the corresponding R, G, B data, respectively, received from source device 140 over the serial link 150. The data is received according to the data stream sequence as will be described below in more detail with reference to FIG. 2A or FIG. 2B. Each of the R, G, B video data is encoded into a sequence of data streams according to the embodiments shown in FIG. 2A or FIG. 2B, as explained above. One example of the circuitry of the de-serializers/decoders 122, 124, 128 configured to decode the video data encoded according to the encoding scheme of FIG. 2A or 2B is described below in detail with reference to FIG. 3. Each of receiver (RX) circuits 116, 118, 120 (see FIG. 1) may be, for example, a differential amplifier or a common gate amplifier, configured to receive the encoded R, G, B data transmitted on the serial link 150. The decoded R, G, B video data is provided to video data sink 130, such as a display, for display or further processing.

FIG. 2A illustrates an exemplary data stream format of uncompressed video data transmitted in the video transmission system using a fixed unit interval serial link, according to a first embodiment. The data stream 200 according to the first embodiment of FIG. 2A has a fixed packet length with multiple fields. The fields include a start of packet (SOP) field 202, a packet format field 204, a clock offset 206 from the SOP field, and a plurality of payload fields 208. Payload field 208 may include video, audio, or other control information. Each of the fields 202, 204, 206, 208 is positioned at a fixed location within the fixed length packet 200. On the other hand, the number of pixel payload fields 208 (corresponding to the length of a full frame) may vary. The frame is represented by multiple packets communicated sequentially.

More specifically, the SOP field 202 indicates the start of each packet 200 and may be of a predetermined code indicating to a decoder in the sink device 160 the start of each packet 200. Packet format field 204 has a predetermined number of bits, and includes a variety of data indicating the format of the packet 200, such as the number of pixels represented in each packet 200, control data for controlling the sink device 160, the type of color depth used (i.e., the number of bits per video pixel), and type of data (e.g., video, audio, control, etc.)

The clock offset 206 from SOP field indicates the timing position corresponding to the transition of the pixel clock within the fixed UI data stream 200. More specifically, the clock offset 206 from SOP field denotes the time at which the pixel clock should transition with respect to the SOP field 202 when regenerated at the sink device 160. The clock offset 206 is indicated in terms of an integer parameter indicating the number of unit intervals (UI's) from the SOP 202 to the nearest unit interval at which time the pixel clock transitions within the serial data. In other words, the clock offset 206 is used as an offset to denote the timing at which the pixel clock should transition within the data stream from a timing reference, which is the SOP 202 in the embodiment of FIG. 2A, although other fields such as the format field 204 may also be used as the timing reference in other embodiments. This embodiment is based on the assumption that the transport clock rate (or baud rate) of the serial link 150 is much higher than the pixel clock frequency. For example, a typical frame refresh rate may be 60 Hz or 120 Hz and the transport clock frequency (or baud rate) may be 6 Gigabits/second or 10 Gigabits/second, making it possible to denote the location of the display clock transition in terms of the number of unit intervals from the SOP 202. For a more specific example, 1080p video data with 120 Hz frame refresh rate may have a pixel clock period of approximately 3 nsec ( 1/297 MHz). If a USB 3.0 interface is used as the serial link 150, the transport clock frequency is 200 psec. Thus, the effective resolution of the offset field 206 is approximately 6% (200 psec/3 nsec=6%), which provides sufficient resolution for the offset field 206 to denote the relative position of the pixel clock with respect to the SOP field 202 in terms of the number of unit intervals.

While the clock offset field 206 indicates the timing position of the pixel clock within one data stream, the frequency of the pixel clock may also be derived from the clock offset field 206. This is possible because the clock offset field 206 is available in each packet 200 at a fixed location, and the rate of repetition of such clock offset field 206 from packet to packet can be used to derive the frequency of the pixel clock.

In an alternate embodiment, a descriptor could be included in the packet format field 204 to indicate that the clock offset field 206 is to be ignored or masked, and therefore not interpreted by the sink device 160. In one embodiment, such descriptor could be a single dedicated bit setting. Also note that the clock offset 206 may be set to a value indicating a position of the pixel clock past the end of the packet 200, which will mean that there is no pixel clock in the packet 200.

Following the clock offset field 206 is a payload field 208. In the case of video transmission, each of the pixel payload fields 208 includes the actual uncompressed video data corresponding to the R, G, B video data. A pixel typically has three colors (R, G, B) and each color is encoded with some number of bits representing the color intensity. If the serial link 150 is much faster than the display data bandwidth, the payload field 208 may also include dummy or blank data. In one embodiment, the number of pixel payload fields 208 may correspond to the number of bits used to transmit one pixel using one packet 200, with each pixel payload field 208 corresponding to each bit encoding the pixel. The payload data 208 may be scrambled, encrypted, or otherwise encoded as necessary for the particular application in which the video transmission system is used. The clock offset field 206 may also be scrambled or otherwise encrypted to protect against the recovery of the pixel clock.

In still another embodiment, multiple streams of video data addressed to multiple display devices may be aggregated into one data stream, and the uncompressed video stream could be directed to one of a plurality of addressable display devices that function as the sink device 160. In such embodiment, a portion of the packet format field 204 could contain the destination display address, or otherwise denote that the display address is contained within the payload field 208. The data payload and the clock offset would then be directed to the addressed display device where the payload would be interpreted and displayed. Packets not intended for a sink device would be passed through.

FIG. 2B illustrates an exemplary format of uncompressed video data transmitted in the video transmission system using a fixed unit interval serial link without a fixed packet format, according to a second embodiment. The data stream 250 according to the second embodiment of FIG. 2B has multiple fields. The fields include control character field 252, a clock offset field 254 from preceding control character field, another control character field 256, and a plurality of pixel payload fields 258. The contents of the stream 250 are set by placement of the control characters 252, 256. Each of the fields 252, 254, 256, 258 has fixed size but is not positioned at a fixed location within the serial data stream 250. The uncompressed video data may be re-constructed by the data sink 160 by interpretation of the payload fields 258 and the instructions or control represented by the control characters 252, 256.

More specifically, the control character fields 252 or 256 may be used to denote critical scan line information or pixel information. For example, control character fields 252, 256 may indicate the start of a line or a frame, pixel sequence information, valid data as opposed to IDLE characters, out of band data, audio data, etc. An IDLE character is an example of a control character, and denotes “do nothing” but may provide clock information for clock/data recovery in the data sink 160. Clock offset field 254 indicates the phase information of the transition of the pixel clock within one data stream. More specifically, the clock offset field 254 denotes the timing at which the pixel clock should transition with respect to the immediately preceding control character field 252. The clock offset 254 is indicated in terms of an integer parameter corresponding to the number of unit intervals from the immediately preceding control character field 252 specifically designated to indicate that the clock offset count will follow to the nearest unit interval at which time the pixel clock transitions within the data stream.

Following the clock offset field 254 and the control character field 256 are a plurality of pixel payload fields 258. Each of the pixel payload fields 258 includes uncompressed R, G, B video data.

In still another embodiment, multiple streams of video data addressed to multiple display devices may be aggregated into one data stream, and the uncompressed video stream could be directed to one of a plurality of addressable display devices that function as the sink device 160. In such embodiment, a control character field 256 may be used to alert the receiving sink device 160 that the next character is an address corresponding to the destination display device, in which case such alerted sink device 160 should accept and process the subsequent data until another address destination is selected. In another embodiment, the occurrence of a control character in a data stream could be used to alert the video sink device 160 to the format of the payload data and how the payload should be interpreted, e.g., the number of bits per pixel.

FIG. 3 illustrates the circuitry of the video transmission system using a fixed unit interval serial link, according to one embodiment. The circuitry of FIG. 3 illustrates the encoder/serializer 104 and the de-serializer/decoder 122 used to transmit R video data via the fixed rate serial link 152. Identical circuitry may be used to transmit G and B video data or audio data from the video source 140 to the video sink 160 in a similar manner via the serial links 154, 156, respectively, although they are not shown herein for simplicity of illustration.

Encoder/serializer 104 includes multiplexers 312, 304, a controller 310, a counter 308, a FIFO buffer 302, an encoder 104, and a serializer circuit 380. The serializer circuit 380 includes a multiplexer 314, a clocked data transmitter 316, and a clock generator (CLK) 308. Clock generator 308 generates the transport clock (TCLK) that determines the unit interval (UI) of channel 152. Encoder/serializer 104 generates serialized, encoded video data 354 that is transmitted to de-serializer/decoder 122 at a fixed baud rate of the transport clock (TCLK) via the signaling channel 152. In other words, the baud rate (TCLK) and thus the unit interval (UI) do not vary according to the display parameters of the video pixel data 318.

Controller 310 receives the pixel clock (Pixel CLK) and generates control signals 342, 368 at every cycle of Pixel CLK. Control signal 342 includes a read pointer (RP) signal and a selection signal (SEL) that are enabled at every cycle of Pixel CLK. RP contains the index into the FIFO buffer 302 that contains the next byte to be transmitted. SEL is used to select either the pixel data 318 or the count 344 from counter 308. Counter 308 is an up counter and counts the number of cycles of the transport clock (TCLK) until it receives an enabled control signal 368 from controller 310 indicating to the counter 308 to release the count 344. Thus, counter 308 outputs a signal 344 that represents the number of unit intervals (UI's) at every cycle of Pixel CLK. Thus, signal 344 indicates the duration between each Pixel CLK cycle counted in terms of an integer number of UI's, referenced to the immediately preceding Pixel CLK cycle. The value of signal 344 thus can be used to derive the clock offset field 206 (FIG. 2A) or the clock offset field 254 (FIG. 2B).

Upon receiving a Pixel CLK signal, controller 310 selects data selection multiplexer 312 to inject the count value 344 into the FIFO 302 by selecting the MUX position using the selection signal (SEL) and then adjusting the read pointer (RP) in the FIFO multiplexer 304. The count value on counter 308 will also be cleared to zero and the counter 308 will then count up until the next Pixel CLK is asserted.

More specifically, multiplexer 312 receives video data 318 (including pixel payload data and other control data) and the count 344, and outputs the video data 318 when SEL is not enabled but outputs the count 344 when SEL is enabled. The output 346 of multiplexer 312 thus becomes the video data 318 with the count 344 injected therein at each cycle of Pixel CLK. In essence, Pixel CLK is encoded in terms of an integer count of the number of UI's between Pixel CLK cycles, and injected into the pixel data at each cycle of Pixel CLK. FIFO buffer 302 stores the output 346 of multiplexer 346 which is released via multiplexer 304 to encoder 104 when the read pointer (RP) is enabled. Thus, FIFO buffer 302 provides the video data 318 and the count 344 to encoder 104 at each cycle of the pixel CLK. Although FIG. 3 illustrates injecting the count 344 indicating the clock offset for the display clock into the data stream at each cycle of the pixel clock, FIG. 3 may be modified to inject the clock offset at each cycle of any display clock that is proportional to the scan refresh clock. Other calculations may be required to convert the counter value 344 to the clock offset value required for transmission, such as addition, subtraction, or modulo division.

Then, encoder 104 uses the video data 318 and the count 344 to encode the data stream according to the embodiment of FIG. 2A or FIG. 2B. If the data stream is encoded according to the embodiment of FIG. 2A, the video data 318 (including video data and other control data) is used to encode the SOP field 202, the packet format field 204, and the pixel payload fields 208, and the count 344 is used to derive and encode the clock offset field 206. If the data stream is encoded according to the embodiment of FIG. 2B, the video data 318 (including pixel payload data and other control data) is used to encode the control characters 252, 256 and the pixel payload fields 258, and the count 344 is used to derive and encode the clock offset field 256. The encoded data 352 generated by encoder 104 is then provided to serializer 380.

Multiplexer 314 converts the byte-wide encoded data 352 into serialized bit-wide data 353, which is output 354 to serial link 152 via D-flip flop 316 at the baud rate (TCLK). Thus, serializer 380 converts the byte-wide encoded data 352 to bit-wide data 354, which is transmitted via the channel 152 at each cycle of the transport clock (TCLK). Each bit of the encoded data 354 is transmitted via channel 152 during a constant UI that does not vary regardless of the display parameters of the data. One would appreciate that there are many different ways to realize the serializer function 380. For example, the baud rate may be one-half the serialized bit data rate and that two data bits may be clocked per every TCLK cycle.

Decoder/de-serializer 122 includes counter 336, a multiplexer 328, decoder 122, a FIFO buffer 330, a sampling data receiver 332, and a de-serializer circuit 381. The de-serializer circuit 381 includes a multiplexer 324, a D flip-flop 322, and a clock recovery circuit (CRC) 338. D-flip flop 322 receives the serialized, encoded data 354 and provides the received data 356 to multiplexer 324, which then de-serializes the received data 356 to generate byte-wide data 358. CRC circuit 338 uses the received data 358 to recover the transport clock (RCLK), which is also used to clock the D-flip flop 322 for output 356 of the received data. CRC circuit 338 can be any type of conventional clock recovery circuit known in the art. In one exemplary and non-limiting embodiment, the RCLK frequency may be one-half of the data link baud rate, where two data symbols are sampled for each RCLK cycle time.

Decoder 122 decodes the received byte-wide data 358 according to the embodiment of FIG. 2A or FIG. 2B. If the data stream is encoded according to the embodiment of FIG. 2A, the SOP field 202, the packet format field 204, and the payload fields 208 are converted back to data 362 (including pixel data, audio data, and other control data) and the clock offset field 206 is converted back to offset count data 340. If the data stream is encoded according to the embodiment of FIG. 2B, the control characters 252, 256 and the pixel payload fields 258 are converted back to signal 362 and the clock offset field 256 is converted back to offset count data 340. Decoder 122 also generates control signal 361 that is enabled each time the clock offset appears in the received data 358. Control signal 361 includes selection signal (SEL) and load counter signal (LOAD COUNTER) that are enabled each time the clock offset appears in the received data 358. Multiplexer 328 outputs the video data 362 if SEL is not enabled and outputs the offset count data 340 if SEL is enabled. Such offset count data 340 is loaded to counter 336 each time LOAD COUNTER is enabled.

Counter 336 is a down counter and counts down the number of UI's of the transport clock (RCLK) from the count offset 340 until it reaches zero, at which time the Pixel CLK 366 is generated. Thus, Pixel CLK 366 is generated each time the offset duration indicated by the offset count 340 in terms of the number of UI's of the RCLK passes, consistent with the Pixel CLK used in the encoder/serializer 104. Thus, decoder/de-serializer 122 can regenerate the Pixel CLK without receiving the Pixel CLK itself via channel 152. Thus, unlike the serial links used by conventional HDMI/DVI, the video transmission system used by the embodiments herein does not require a separate serial link (channel) for transmitting the Pixel CLK (or other display clock information). The Pixel CLK and other display clocks (line clock, frame refresh clock, etc.) may be derived from the clock offset count 344, 340 set with respect to a certain time reference (SOP 202 or control character 252) in terms of the number of UI's from a time reference. Also, the recovered video data 362 is stored in a FIFO buffer 330 and loaded to D-flip flop 332 through multiplexer 383 using the RP as an index into the video data stored in FIFO buffer 330, until it is output 334 by D-flip flop 332 at each cycle of the derived pixel CLK 366.

Note that, with the embodiments described herein, the display clock (Pixel CLK 366) is effectively quantized in units of the number of UI's of the transport clock (TCLK), and thus quantization error may be introduced during the quantization process as carried out by controller 310 and counter 308. Such quantization error is expected to look like high frequency jitter. In this regard, the recovered Pixel CLK 366 may be input to an analog or digital phase locked loop (PLL) circuit. PLL circuits generally have the properties of a low-pass filter. Thus, the PLL circuits can regenerate the Pixel CLK, low-pass filtered to remove any high frequency noise or jitter in the recovered Pixel CLK 366.

Such quantization error in the offset count 344 may also be reduced by adding random error (dither) or other types of error to the encoding offset count 344 to average out high frequency noise, which may obviate the need for a digital PLL circuit. For example, such dither may be added to the counter output value 344 by counter 308 by randomly incrementing the count value 344 by +1, 0, −1, etc. For another example, the count value 344 may otherwise be processed at the output of counter 308 by filtering or sampling rate conversion (decimation or interpolation) to remove high frequency noise. For still another example, the received count value 340 from multiplexer 328 may be processed prior to generation of the Pixel CLK 366 by filtering or by sampling rate conversion (decimation or interpolation) to remove high frequency noise. In addition, the clock offset count 344 may be scrambled or otherwise encoded to prevent detection for purposes of content protection. Such scrambling or other encoding, if provided, would also be performed by encoder 104 and decoded by decoder 122. Finally, the transport layer of the serial link 152 (i.e., the TLCK) may be spread spectrum clocked to further complicate the recovery of the display clock, to reinforce content protection.

Upon reading this disclosure, those of ordinary skill in the art will appreciate still alternative structural and functional designs for transmission of data over a serial link, through the disclosed principles of the present disclosure. Thus, while particular embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure herein without departing from the spirit and scope of the disclosure as defined in the appended claims.

What is claimed is:

1. In a source device, a method of transmitting data, the method comprising:
receiving data including at least payload data and information on a payload clock corresponding to the payload data;
encoding the data into a plurality of data streams, each data stream including a plurality of fields, the fields including at least a clock offset field and one or more payload data fields, the clock offset field including phase information indicative of a phase of the payload clock offset with respect to a time reference; and
outputting the encoded data for transmission via a serial communication link with a substantially constant unit interval for transmission of each symbol of the encoded data.

2. The method of claim 1, wherein no payload clock itself is transmitted with the encoded data via the serial communication link.

3. The method of claim 1, wherein the payload clock offset is indicated in terms of number of unit intervals offset from the time reference.

4. The method of claim 1, wherein each data stream has a fixed packet length, and the fields of each packet have variable lengths but are positioned at predetermined locations within each packet.

5. The method of claim 4, wherein the time reference is a start of packet field of the data stream.

6. The method of claim 1, wherein each data stream has a variable length set by placement of one or more control characters, and the fields of each data stream have fixed lengths but are positioned at variable locations within each data stream.

7. The method of claim 6, wherein the time reference is one of the control characters preceding the clock offset field in each data stream.

8. The method of claim 1, wherein error is added to the payload clock offset to reduce quantization error in the payload clock offset.

9. The method of claim 1, wherein the payload clock offset is encoded to prevent detection.

10. The method of claim 1, wherein the data is video data and the payload clock is a display clock.

11. In a sink device, a method of receiving data, the method comprising:
receiving encoded data via a serial communication link with a substantially constant unit interval for transmission of each symbol of the encoded data, the encoded data comprised of a plurality of data streams, each data stream including a plurality of fields, the fields including at least a clock offset field and one or more payload data fields, the clock offset field including phase information indicative of a phase of a payload clock offset with respect to a time reference; and
decoding the data streams into data including at least payload data and a payload clock, the payload clock being derived from the payload clock offset with respect to the time reference.

12. The method of claim 11, wherein no payload clock itself is received with the encoded data from the source device.

13. The method of claim 11, wherein the payload clock offset is indicated in terms of number of unit intervals offset from the time reference.

14. The method of claim 11, wherein each data stream has a fixed packet length, and the fields of each packet have variable lengths but are positioned at predetermined locations within each packet.

15. The method of claim 14, wherein the time reference is a start of packet field of the data stream.

16. The method of claim 11, wherein each data stream has a variable length set by placement of one or more control characters, and the fields of each data stream have fixed lengths but are positioned at variable locations within each data stream.

17. The method of claim 16, wherein the time reference is one of the control characters preceding the clock offset field in each data stream.

18. The method of claim 11, wherein error is added to the payload clock offset to reduce quantization error in the payload clock offset.

19. The method of claim 11, wherein the payload clock offset is encoded to prevent detection.

20. The method of claim 11, wherein the data is video data and the payload clock is a display clock.

21. A source device configured to transmit data to a sink device via a serial communication link, the source device comprising:
an encoder configured to receive data including at least payload data and information on a payload clock corresponding to the payload data and to encode the data into a plurality of data streams, each data stream including a plurality of fields, the fields including at least a clock offset field and one or more payload data fields, the clock offset field including phase information indicative of a phase of the payload clock offset with respect to a time reference; and
a transmitter configured to transmit the encoded data to the sink device via the serial communication link with a substantially constant unit interval for transmission of each symbol of the encoded data.

22. The source device of claim 21, wherein the encoded data does not include the payload clock itself.

23. The source device of claim 21, wherein the payload clock offset is indicated in terms of number of unit intervals offset from the time reference.

24. The source device of claim 21, wherein each data stream has a fixed packet length, and the fields of each packet have variable lengths but are positioned at predetermined locations within each packet.

25. The source device of claim 24, wherein the time reference is a start of packet field of the data stream.

26. The source device of claim 21, wherein each data stream has a variable length set by placement of one or more control characters, and the fields of each data stream have fixed lengths but are positioned at variable locations within each data stream.

27. The source device of claim 26, wherein the time reference is one of the control characters preceding the clock offset field in each data stream.

28. The source device of claim 21, wherein the data is video data and the payload clock is a display clock.

29. A sink device configured to receive data from a source device via a serial communication link, the sink device comprising:
a receiver configured to receive encoded data from the source device via the serial communication link with a substantially constant unit interval for transmission of each symbol of the encoded data; and
a decoder configured to decode the received encoded data into data including at least payload data and a payload clock, the encoded data comprised of a plurality of data streams, each data stream including a plurality of fields, the fields including at least a clock offset field and one or more payload data fields, the clock offset field including phase information indicative of a phase of a payload clock offset with respect to a time reference, and the payload clock being derived from the payload clock offset with respect to the time reference.

30. The sink device of claim 29, wherein the encoded data received from the source device does not include the display clock itself

31. The sink device of claim 29, wherein the payload clock offset is indicated in terms of number of unit intervals offset from the time reference.

32. The sink device of claim 29, wherein each data stream has a fixed packet length, and the fields of each packet have variable lengths but are positioned at predetermined locations within each data stream.

33. The sink device of claim 32, wherein the time reference is a start of packet field of the data stream.

34. The sink device of claim 29, wherein each data stream has a variable length set by placement of one or more control characters, and the fields of each data stream have fixed lengths but are positioned at variable locations within each data stream.

35. The sink device of claim 34, wherein the time reference is one of the control characters preceding the clock offset field in each data stream.

36. The sink device of claim 29, wherein the data is video data and the payload clock is a display clock.
